(19) United States
(12) Patent Application Publication
(10) Pub. No.: US 2005/0211339 A1
(43) Pub. Date: Sep. 29, 2005

(54) Method for clamping a knife in a disk chipper and a knife clamp for a knife assembly

(76) Inventor: Arvo Jonkka, Pori (FI)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 10/517,845

(22) PCT Filed: Jun. 18, 2003
(86) PCT No.: PCT/FI03/00495

§ 371 Date: Dec. 15, 2004

(30) Foreign Application Priority Data
Jun. 26, 2002 (FI) 20021248

(51) Int. Cl. B27C 1/00; B27M 1/08; B27C 9/00; B27L 11/00

(52) U.S. Cl. 144/373; 144/176

(57) ABSTRACT

The invention concerns a method for clamping a knife of a disc chipper, wherein the knife is pressed from the knife disc via knife a clamp against a wear plate in a diagonal position (a) with respect to the plane of the knife disc with a compressive force (N) substantially parallel with the axis of the knife disc. According to the invention, the compensating force of the force directed to the knife clamp, caused by the diagonal position (a) of the knife and transversal to the compressive force (N) is exerted to the wear plate.

The present invention concerns a method for clamping a knife of a disc chipper against a wear plate by means of a knife press between the wear plate and the knife disc. The invention also concerns a knife clamp, that is pressed by a device supported from the knife disc and that is supported to the knife and the wear plate.

Disc chippers are generally used in the wood processing industry for chipping wood prior to the further processing. The rotating disc of a chipper is equipped with knives attached evenly distributed thereto cutting chips from a log against a counter knife. The knives are generally attached to the disc through separate knife presses that are locked in position generally by means of a compressive force provided by bolts. The knife press by means of which the knife is pressed in its position is in this publication referred to as knife clamp.

When attaching a knife in its position in the knife disc according to a method of prior art, the knife clamp and the knife are pressed with bolts against the wear plate. The method is described e.g. in the publication U.S. Pat. No. 6,056,030. The bolts are parallel with the axis of the knife disc. The bolts have their support from the knife disc and move the knife clamp and the knife in the axial direction of the knife disc, away from the knife disc towards the inclined surface of the wear plate, against which the knife is positioned. This positioning surface of the knife in the wear plate deviates due to its inclination from the direction perpendicular to the pressing motion of the clamp, whereby the knife clamp and the knife are subject to forces from the wear plate, that tend to move the knife clamp aside from the direction of the desired pressing motion. Against this transversal motion the knife clamp is supported from the knife disc near the compressing bolt. A friction force is generated to the point of support resisting the movement of the knife clamp during the compressing process.

The method in accordance with the present invention is characterized in, that the point of support preventing the transversal movement of the knife clamp is positioned in the wear plate on the area of the plane between the knife and the knife clamp, said area facing the knife, whereby the transversal force required for attaching the knife increases the compressive force between the knife clamp and the knife. The knife clamp in accordance with the invention substantially takes the support of the knife clamp against the transversal movement from the wear plate by means of a bracket of the knife clamp. Due to the method, the compressive force of the knife clamp can be provided also with other methods than bolt attachment, because a supporting surface of the knife disc under the knife clamp is not essential.

The invention and its details will now be described in more detail with reference to the enclosed drawings, where

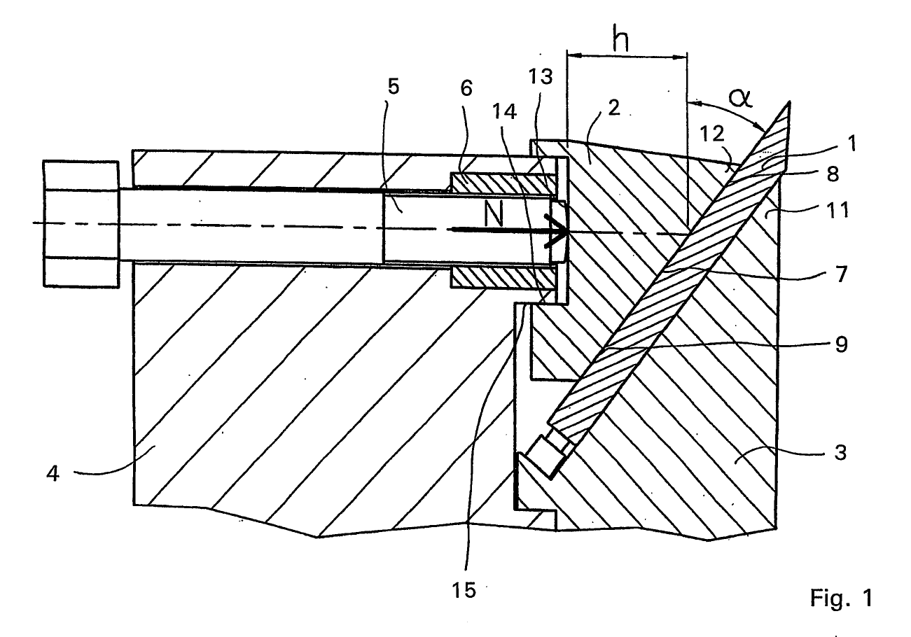

FIG. 1 shows a traditional knife assembly and knife clamp of a disc chipper,

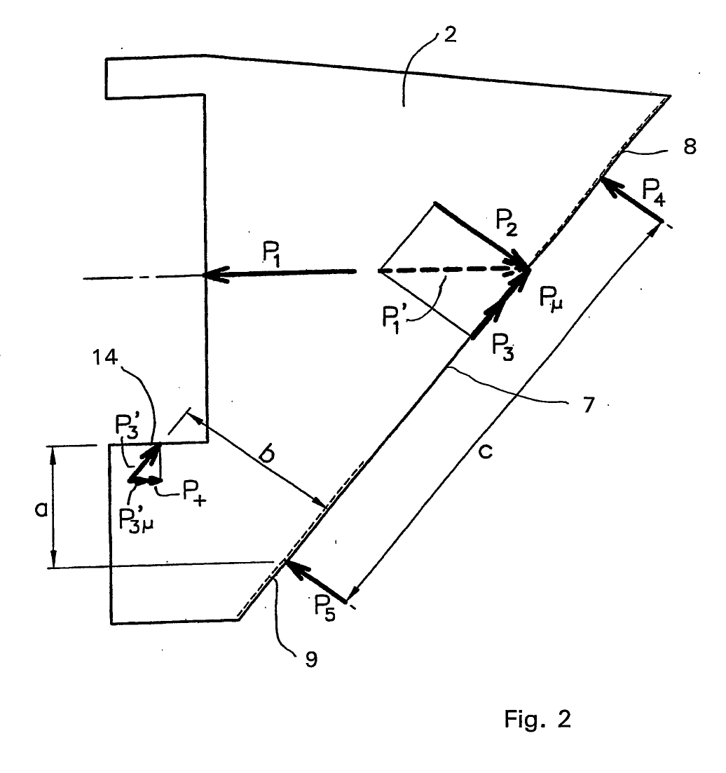

FIG. 2 shows the forces directed to the knife clamp,

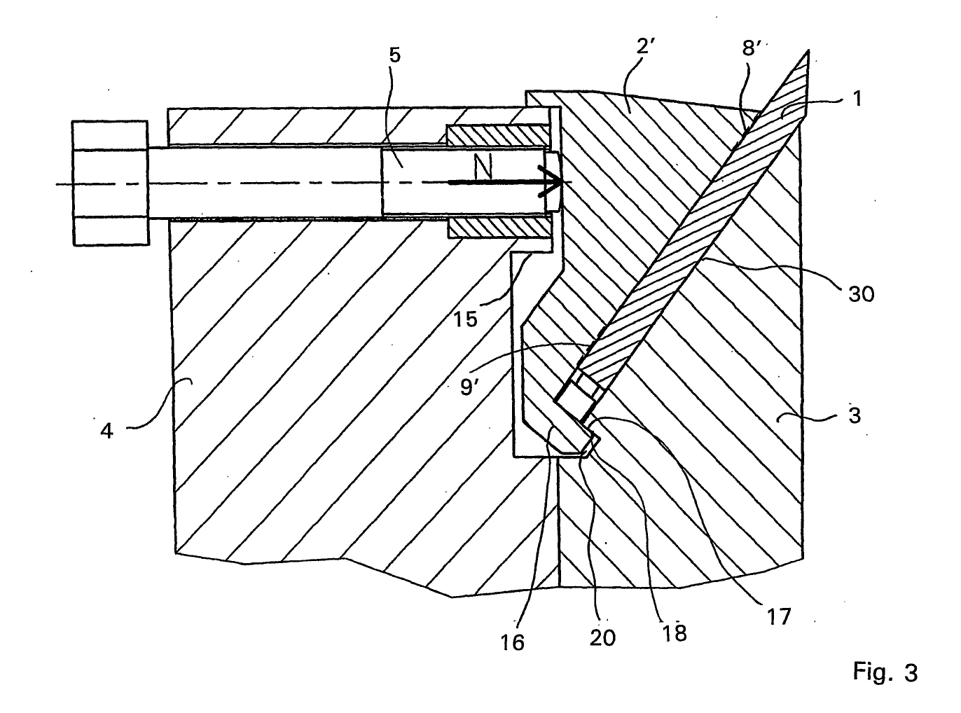

FIG. 3 shows a knife clamp according to the present invention,

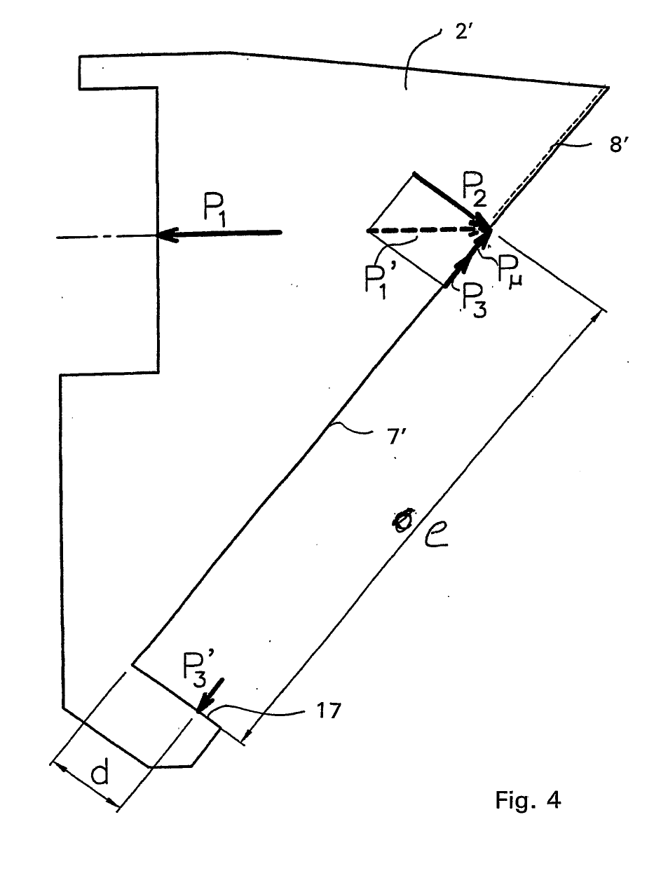

FIG. 4 shows forces directed to the knife clamp according to the present invention, and

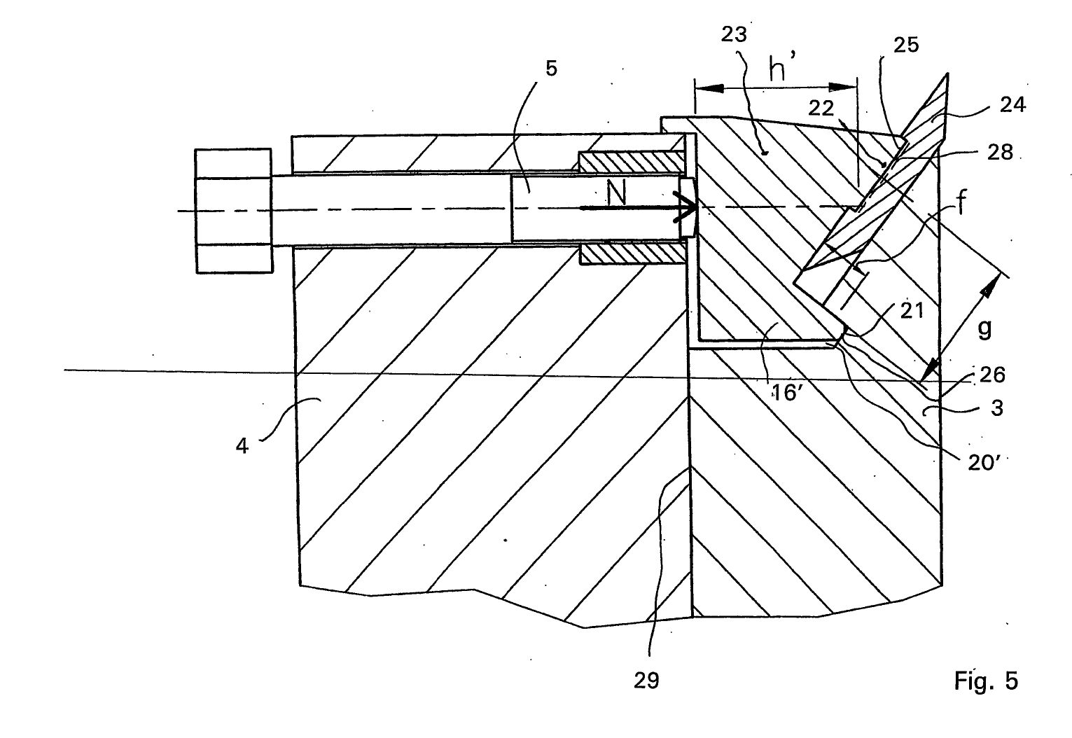

FIG. 5 shows a preferred construction according to the present invention.

FIG. 1 shows a generally used knife assembly. Knife 1 is attached in its place by pressing the knife by means of a knife clamp 2 against a wear plate 3. Bolts for attaching the wear plate to the knife disc 4 is not shown in the figure. The knife clamp 2 is pressed in the direction of arrow N against the knife 1 by means of a bolt 5. Bolt 5 is supported from the knife disc 4 by means of a hardened threaded bushing 6. The surface 7 of the knife clamp placed against the knife 1 is formed slightly concave, so that the knife clamp is supported against the knife at points 8 and 9. Thus, the knife 1 has the best possible support from the knife clamp 2 despite of small inaccuracies in manufacturing. The most important thing is to the have the knife supported in the best possible way near the point of the knife by means of surface 8.

It has been noticed in the practice that the point portion 11 of the wear plate 3 slightly yields due to the force N. Thus, also the knife 1 and the knife clamp 2 must turn from 0.2 to 0.3 mm at the point portion 12 thereof. Turning of the knife clamp and tensioning of the bolts 5 are contributed by the rounded ends 13 of the bolts.

Against the direction perpendicular to the pressing motion, the knife clamp is supported by means of the surface 14. The surface 14 is supported against the counter surface 15 in the knife disc and a friction force caused by the supporting force is generated between these surfaces.

During the chipping process the point 11 of the wear plate is in a small continuous bending motion and the size of said friction force varies continuously. In praxis this variation causes a pulsating effect to the compressive force of the point 8 of the knife clamp. Function of the knife clamp is to keep the knives firmly attached to the chipper and another main function is to maintain an adequate compressive force on the area of the point 8. Decreasing of said compressive force is substantially influenced not only by the bending of the wear plate but also the force turning the knife clamp caused by the compressive force between the surfaces 14 and 15, said force being dependent on the height h and the angle α of the clamp, as shown in FIG. 1. The height of the clamp is dependent on the adequate stiffness of the clamp and the distance between the screws 5. Angle α of the knife is in general about 36-40 degrees and it is influenced by the sharpening angle of the point of the knife.

Referring to FIG. 2, the arrows describe forces exerted by the knife clamp 2 to the other parts of the knife disc. For simplicity of the force figure, the concavity of the surface 7 of the knife clamp against the knife is not taken into account. The compressive force caused by the bolt is P₁ (=N). The correspondingly big supporting force P₁′ exerted to the knife 1 is divided into component P₂ effecting against the knife and component P₃+P_{μ} effecting in the direction of the knife. Force P₃ parallel with the surface of the knife, which is a residual force taking into account the friction force caused by P₂, tends to move the knife clamp from its place. The size of the force is dependent on the friction between the knife and the knife clamp. The surface of the knife clamp facing against the knife of the knife clamp is effected by the force P₃ coming from the knife, and force P₃′ affecting the knife disc is formed to the supporting surface 14. Forces P₃μ′ and P₊ parallel with the surface 14 are formed thereby.

Force P₂ effects in perpendicular direction to the surface of the knife and it is divided into counter forces P₄ and P₅, which are located on their respective areas of influence 8 and 9. Most important is that the force P₄ maintains adequate. Distance of the above mentioned pair of forces is c and the size of this distance varies to some extent according to inaccuracies of the surfaces of the knife 1 and the knife clamp 2. Force P₃ moving aside the knife clamp from the direction of effect of force P₁ gives a decreasing effect (P₄) and an increasing effect (P₅) according to formula (b/c) P₃ to the pare of forces P₄-P₅. This results in additional need of force P₁, when a certain level of force P₄ is needed.

A bigger height h (FIG. 1) also increases the dimension b and requires increasing of the clamping force P₁. Harmful effect of this problem increases during the operation of the chipper, whereby the vibration decreases the influence of the friction and the compressive force of the area 8 can decrease as much as 50%. A minor effect increasing the force P₁ comes from force P₊ according to formula (a/c) P₊. This increasing portion of the main force P₁ ranges from 3 to 10%. When the knife 1 gets narrower due wearing, the dimension a is 0 and there is no favourable effect P₊.

A knife clamp 2′ according to the invention is shown in FIG. 3. The knife clamp 2′ is supported against the perpendicular direction parallel with the compressive motion N by means of the surface 17 of the bracket 16. Otherwise the knife clamp 2′ corresponds to that shown in FIG. 1. Counter surface for the bracket 16 is the surface 18 of the groove 20 in the wear plate 3. The system according to the present invention has that considerable benefit that no supporting surface 15 is needed and the knife clamp according to FIG. 3 can also be used with other attaching methods than bolts.

In the knife clamping system of FIG. 3 according to the present invention, the support of the transversal force effected by the clamping force N of the knife clamp has been moved over to the other side of the surface 30 between the knife 1 and the knife clamp 2′ compared with the system shown in FIG. 1. The force pattern of the construction of FIG. 3 shown in FIG. 4 shows that correspondingly force P₃ parallel with the surface of the knife as well as a corresponding supporting force P₃′ are generated in this construction to the surface 17. The force increasing the force P₂ against the knife can be calculated from the FIG. 4 by formula (d/e) P₃′. As it is evident from said formula, that a long surface 7′ against the knife is unfavourable with respect to the increasing of force P₂. A wide knife 1 according to FIG. 3, however, requires a wide knife clamp 2′.

The advantages of the present invention become evident from the construction in accordance with FIG. 5, where the knife 24 is led in position through the groove 25 by means of a projection 22 of the knife clamp 23. Turn knife 24 equipped with two points is much narrower than the knife of FIGS. 1 and 3 and requires thereby a better support. Thereby the supporting of the knife 24 is a much more demanding task and the knife clamp according to the invention and FIG. 5, where the relation of dimensions f/g is bigger than the relation d/e according to FIG. 3 is a suitable solution for this purpose. An adequate strength is also reached without any problems, because height h′ does not matter.

A wide knife as shown in FIG. 3 requires two supporting regions 8′ and 9′ between the knife clamp and the knife. There the bracket 16 cannot be used for supporting the force P₂, because a three-point or three-area supporting is not successful due to fabrication inaccuracies. The knife clamp according to FIG. 5, instead, forms only one supporting area 28 against the knife from the bottom of the groove 25. Another balancing support is provided by the bottom surface 26 of the groove 20′, against which the corresponding surface 21 of the bracket 16′ is supported, whereby bracket 16′ receives the force P₃′ and a part of the force P₂. Thereby an adequate clamping of the knife can be achieved with a reasonable force N.

The arrangement in accordance with FIG. 5 has an additional advantage therein that the knife disc 4 has a surface 29 with no groove. This means considerable savings in costs of machining.

Oversized compressive forces require a large number of clamping screws and big forces result in durability problems of threads and bending of the wear plate 3 as well as in permanent deformation, which causes functional disturbances and need of changing components. By means of a method and a knife clamp in accordance with the present invention, the disadvantages mentioned above can be avoided.

1. A method for clamping a knife (1%) of a disc chipper, wherein the knife is pressed from the knife disc (4) via knife clamp (2′, 23) against a wear plate (3) in a diagonal position (α) with respect to the plane of the knife disc with a compressive force (N) substantially parallel with the axis of the knife disc, wherein a compensating force of the force directed to the knife clamp, caused by the diagonal position (α) of the knife and transversal to the compressive force (N), is exerted to the wear plate.

2. A method in accordance with claim 1, wherein the compensating force of the transversal force is exerted to the wear plate (3) in parallel direction with the knife (1), facing the wear plate with respect to the plane between the knife and the wear plate, whereby the compensating force brings about a moment that turns the knife clamp and increasing of the compressive force (P₄) on the region (8) of the knife point.

3. A clamping arrangement for a knife of a disc chipper comprising a knife disc (4), a wear plate (3), a knife (1), compressing means (5) and a knife clamp (2′ or 23), wherein a lateral force (P₃) is generated, said force deviating by angle (α) from the perpendicular direction to the compressive force (N), wherein there is a bracket (16) in the knife clamp (2′ or 23), the surface (17) of which receives the generated force (P₃) by supporting itself against a surface (18) of the groove (20) of the wear plate (3).

4. A knife clamp (23) for the clamping arrangement of claim 3, wherein the upper surface (21) of the bracket (16′) is supported to the bottom surface (26) of the groove (20′) of the wear plate (3).

5. A knife clamp in accordance with claim 4, wherein the knife clamp (23) comprises a projection (22) guiding the knife (24) from a groove (25).
